(19) United States
(12) Patent Application Publication
(10) Pub. No.: US 2016/0039316 A1
(43) Pub. Date: Feb. 11, 2016

(54) EASY-ENTRY SYSTEM FOR A VEHICLE SEAT, AND VEHICLE SEAT

(71) Applicant: JOHNSON CONTROLS COMPONENTS GMBH & CO. KG., Kaiserstautern (DE)

(72) Inventors: Thomas DILL, Heiligenmoschel (DE); Heinrich HAMMANN, Teschenmoschel (DE); Wolfgang PLUTA, Heiligenmoschel (DE); Christian WOLF, Katzenbach (DE); Christian MARKEL, Alzey (DE)

(73) Assignee: JOHNSON CONTROLS COMPONENTS GMBH & CO. KG., Kaiserstautern (DE)

(21) Appl. No.: 14/780,245

(22) PCT Filed: Mar. 19, 2014
(86) PCT No.: PCT/EP2014/055519

§ 371 Date: Sep. 25, 2015

(30) Foreign Application Priority Data
Mar. 27, 2013 (DE) 10 2013 205 521.8
Jul. 31, 2013 (DE) 10 2013 215 028.8

(51) Int. Cl. B60N 2/20; B60N 2/22

(52) U.S. Cl. CPC B60N 2/20; B60N 2/2236

(57) ABSTRACT

An easy-entry system for a vehicle seat, having at least one fitting (5) with at least one fitting component (B) and a driver profile (5.1). The at least one fitting component (B) is coupled to a transmission element (6), and an unlocking lever (3) of the easy-entry system is connected at least indirectly to the transmission element (6). A comfort lever (4) of a backrest (1.1) engages with the driver profile (5.1), and a pivot region of the backrest (1.1) is limited by a pawl (7), which engages in the at least one fitting (5), when the easy-entry function is initiated. Engagement of the pawl (7) into the at least one fitting (5) can be cancelled by operating the comfort lever (4) for adjusting a position of the backrest (1.1). A vehicle seat is also provided, including such an easy-entry system.

### CROSS REFERENCE TO RELATED APPLICATIONS

This application is a United States National Phase Application of International Application PCT/EP2014/055519 filed Mar. 19, 2014 and claims the benefit of priority under 35 U.S.C. §119 of German Patent Applications 10 2013 205 521.8 filed Mar. 27, 2013 and 10 2013 215 028.8 filed Jul. 31, 2013 the entire contents of which are incorporated herein by reference.

### FIELD OF THE INVENTION

The present invention relates to an easy-entry system for a vehicle seat and to a vehicle seat with such an easy-entry system.

### BACKGROUND OF THE INVENTION

Various easy-entry systems which are part of a vehicle seat and permit easier entry into a second row of seats of a vehicle are known in the prior art. The easy-entry system is actuable by an unlocking lever, which is customarily arranged on a backrest upper edge of the vehicle seat, as a result of which the backrest of the vehicle seat pivots out of an entry region. If the vehicle seat is arranged on rails, the vehicle seat is additionally or alternatively displaceable in the direction of travel when the unlocking lever is actuated. Furthermore, the vehicle seat has a comfort adjustment of the backrest and a loading floor function. These two functions are actuable by means of a comfort lever.

### SUMMARY OF THE INVENTION

It is an object of the present invention to specify an easy-entry system for a vehicle seat that is improved, in particular simplified, in relation to the prior art, and a vehicle seat.

The object is achieved according to the invention by an easy-entry system having at least one fitting with at least one fitting component and a carry-along profile, wherein the at least one fitting component is coupled to a transmission element, and an unlocking lever of the easy-entry system is connected at least indirectly to the transmission element, wherein a comfort lever of a backrest is in engagement with the carry-along profile, and a pivoting range of the backrest when the easy-entry function is triggered is limited by means of a pawl engaging in the at least one fitting, wherein engagement of the pawl in the at least one fitting can be cancelled by actuating the comfort lever in order to adjust a position of the backrest.

In particular, the fitting of the vehicle seat consists of a fitting upper part, which is arranged on the backrest, and a fitting lower part, which is fastened to a substructure, wherein such a fitting can be arranged on one side of the vehicle seat in each case. The carry-along profile is arranged rotatably in this case in the region of the fitting upper part.

The transmission element is in particular a rod or a tube which connects the fitting component to an optionally present further fitting component, wherein the transmission element is rotatable about the longitudinal axis thereof, as is known from DE 10 2004 008 599 B3. If two fitting components are provided, the fitting components are coupled to the transmission element, wherein the coupling preferably results from an interlocking connection between a respective end of the transmission element and the respective fitting component. In addition, axial securing can be provided, the axial securing being, for example, a “rapid fastener” and, during the installation and during transport of the latching fitting, preventing the fitting parts from being displaced in the axial direction, with the fitting upper parts being able to rotate relative to the fitting lower parts.

In comparison to easy-entry systems known from the prior art, such a design of an easy-entry system of a vehicle seat has a lower weight and can be produced more cost-effectively. Apart from the at least one fitting in the form of a latching fitting, with two fittings preferably being provided, all further parts of the easy-entry system are not located in the load flux.

The fitting can also be designed as a “flange fitting”.

In addition, fewer parts are required for such an easy-entry system, and therefore lower costs are incurred and coordination of Bowden cables for a final fitting in order to limit the pivoting range of the backrest when the easy-entry function is set is not required.

The pivoting range of the backrest is particularly preferably limited by the pawl engaging in a recess of the at least one fitting, and therefore it can be ensured in an advantageous manner that, when the easy-entry function is set, the backrest is securely held in this position.

In an advantageous development, the comfort lever has a profile corresponding to the carry-along profile, as a result of which the comfort lever is coupled to the fitting and both a setting of the backrest in accordance with a position desired by an occupant and positioning of the backrest into a “loading floor position” can advantageously be undertaken. In the loading floor position, the backrest can rest on a seat cushion of the vehicle seat, the seat cushion forming the seat surface.

In a further advantageous refinement, the transmission element is connected to the fitting component in a frictional, interlocking and/or integrally bonded manner. The transmission element is preferably connected to the fitting component in a frictional, interlocking and integrally bonded manner such that the connection is sufficiently stable and the actuation of the unlocking lever in order to set the easy-entry function can be transmitted via the transmission element to the fitting component and therefore to the carry-along profile.

When the unlocking lever as the easy-entry lever is actuated, formations forming the carry-along profile advantageously move without an operative connection within the corresponding profile of the comfort lever. This movement clearance in the form of what is referred to as play or a freewheel prevents movement of the comfort lever, as a result of which the pawl remains in engagement.

In order to permit the actuation of the unlocking lever to be able to be transmitted to the transmission element in an advantageous manner, a tension element, in particular a Bowden cable, which is coupled both to the transmission element and to the unlocking lever, is provided.

The pawl is preferably coupled to a spring element which, on engagement of the pawl in the recess of the at least one fitting, has a residual tension. By means of the residual tension, a formation of noise, in particular by means of the spring element, can be counteracted. The engagement of the pawl in the recess can be cancelled by actuation of the comfort lever, wherein the pawl is positioned in this case counter to the spring force of the spring element and, by means of the spring force acting on the pawl, the latter engages substantially automatically again in the recess of the fitting.

In a particularly advantageous manner, the spring element is a leg spring, wherein one leg is connected to the pawl and a further leg is connected to the backrest of the vehicle seat. As a result, in the event of a relative movement between pawl and backrest, the spring element designed in the form of a leg spring is both pretensionable and also releasable.

In addition, the invention relates to a vehicle seat with such an easy-entry system. Exemplary embodiments of the invention are explained in more detail below with reference to exemplary embodiments.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic perspective view of a supporting structure of a vehicle seat arranged on a rail system;

FIG. 2 is a schematic perspective view of an enlarged detail of the supporting structure;

FIG. 3 is a schematic perspective view of an enlarged detail of the supporting structure, which detail lies opposite the enlarged detail according to FIG. 2;

FIG. 4 is a schematic comfort lever of the vehicle seat and a pawl in a first position;

FIG. 5 is a schematic view of the comfort lever of the vehicle seat and the pawl in a second position;

FIG. 6 is a schematic view of the comfort lever, which is illustrated semi-transparently and is arranged on the supporting structure, and the pawl;

FIG. 7 is a schematic perspective view of the comfort lever;

FIG. 8 is a schematic perspective view of a fitting which is arranged on the supporting structure and on which the comfort lever can be arranged;

FIG. 9 is a schematic perspective view of the comfort lever arranged on the supporting structure and the pawl when the function is not activated;

FIG. 10 is a schematic perspective view of the comfort lever arranged on the supporting structure and the pawl when the easy-entry function is activated;

FIG. 11 is a schematic perspective view of the comfort lever arranged on the supporting structure and the pawl when the comfort lever is actuated;

FIG. 12 is a schematic enlarged detail of a region of the supporting structure, in which region the comfort lever is arranged;

FIG. 13 is a schematic side view of the supporting structure of the vehicle seat with a first position of a backrest according to FIG. 12;

FIG. 14 is a schematic enlarged detail of the region of the supporting structure, in which region the comfort lever is arranged, wherein the backrest is pivoting into an easy-entry position;

FIG. 15 is a schematic side view of the supporting structure of the vehicle seat according to FIG. 14;

FIG. 16 is a schematic enlarged detail of the region of the supporting structure, in which region the comfort lever is arranged, wherein the backrest is in the easy-entry position;

FIG. 17 is a schematic side view of the supporting structure of the vehicle seat according to FIG. 16;

FIG. 18 is a schematic enlarged detail of the region of the supporting structure, in which region the comfort lever is arranged, according to FIG. 12;

FIG. 19 is a schematic side view of the supporting structure of the vehicle seat without actuation of the unlocking lever;

FIG. 20 is a schematic enlarged detail of the region of the supporting structure, in which region the comfort lever is arranged, when the latter is actuated;

FIG. 21 is a schematic side view of the supporting structure when the comfort lever is actuated;

FIG. 22 is a schematic enlarged detail of the region of the supporting structure when the comfort lever is actuated and the backrest is positioned upright;

FIG. 23 is a schematic side view of the supporting structure with the backrest positioned upright;

FIG. 24 is a schematic enlarged detail of the supporting structure with the backrest pivoted in the direction of travel;

FIG. 25 is a schematic side view of the supporting structure with the backrest pivoted in the direction of travel;

FIG. 26 is a schematic enlarged detail of the supporting structure with the backrest pivoted even further in the direction of travel;

FIG. 27 is a schematic side view of the supporting structure with the backrest pivoted even further in the direction of travel;

FIG. 28 is a schematic enlarged detail of the supporting structure with the backrest arranged in the loading floor position; and

FIG. 29 is a schematic side view of the supporting structure with the backrest arranged in the loading floor position.

### DESCRIPTION OF THE PREFERRED EMBODIMENTS

Mutually corresponding parts are provided with the same reference symbols in all of the Figures.

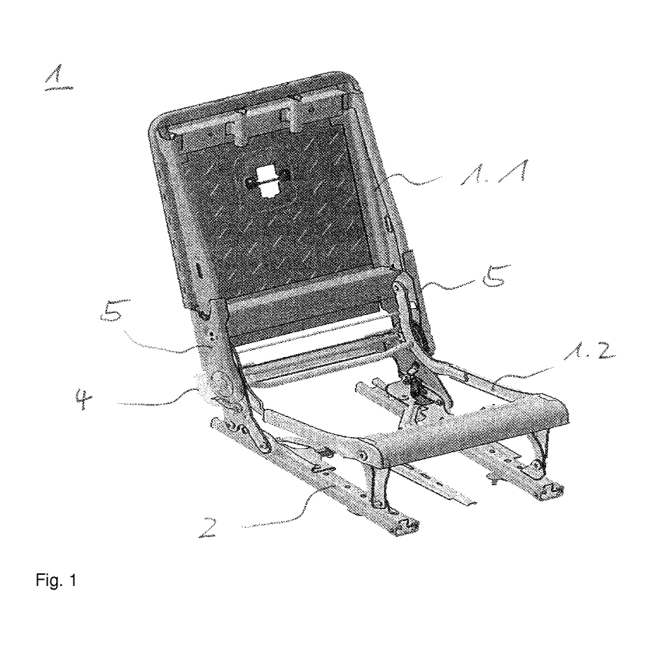

FIG. 1 shows, in a perspective view, a supporting structure 1 of a vehicle seat equipped according to the invention. One section forms a backrest 1.1 and a further section of the supporting structure 1 forms a seat cushion support 1.2.

The vehicle seat is, for example, a front seat or a vehicle seat of a rear row of seats, for example a second row of seats, for a vehicle and is arranged on a rail system 2, as a result of which the vehicle seat is displaceable in the longitudinal direction of the vehicle.

In order to simplify entry into a rear region or a rear row of seats of the vehicle, the vehicle seat has an easy-entry function which can be realized by means of an easy-entry system.

The easy-entry function is an entry aid which permits enlarged and therefore more comfortable access to the rear region, in particular of a two-door vehicle or into a rear row of seats of a multi-door vehicle. By means of the easy-entry system, the vehicle seat is displaced in the direction of travel on the rail system 2 in order to enlarge the entry region, wherein the backrest 1.1 of the vehicle seat is folded forward at the same time. A pivoting range of the backrest 1.1 when the easy-entry function is triggered is limited in this case.

An alternative (not illustrated specifically) may also be a vehicle seat with an easy-entry system, which vehicle seat is not arranged on a rail system 2 and is therefore not displaceable in the longitudinal direction of the vehicle.

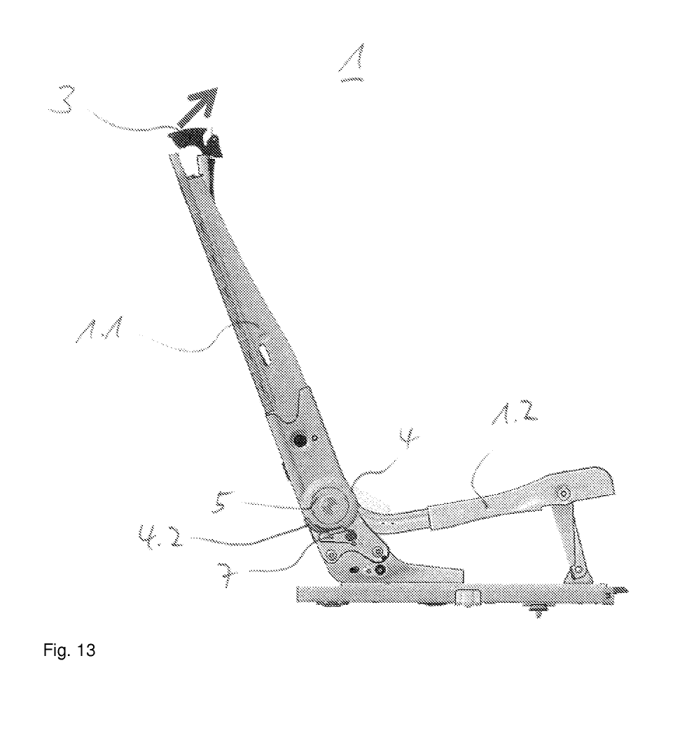

The easy-entry system has an unlocking lever 3 which is arranged on an upper edge of the backrest 1.1 and is illustrated in more detail in FIG. 13. By actuation of the unlocking lever 3, the easy-entry function is triggered, wherein the vehicle seat is displaced and the backrest 1.1 is pivoted forward. Alternatively, the unlocking lever 3 can also be arranged at another suitable position on the vehicle seat or in the vehicle interior.

In addition, a comfort lever 4, which is illustrated semi-transparently, is arranged on one side of the backrest 1.1 and is actuable in order to adjust the backrest 1.1 into a position desired by a vehicle occupant. Furthermore, it is possible, by actuating the comfort lever 4, to position at least the backrest 1.1 in respect of a “loading floor function”, wherein the backrest 1.1 is completely folded over in this position and can rest on a seat cushion (not illustrated specifically) of the vehicle seat.

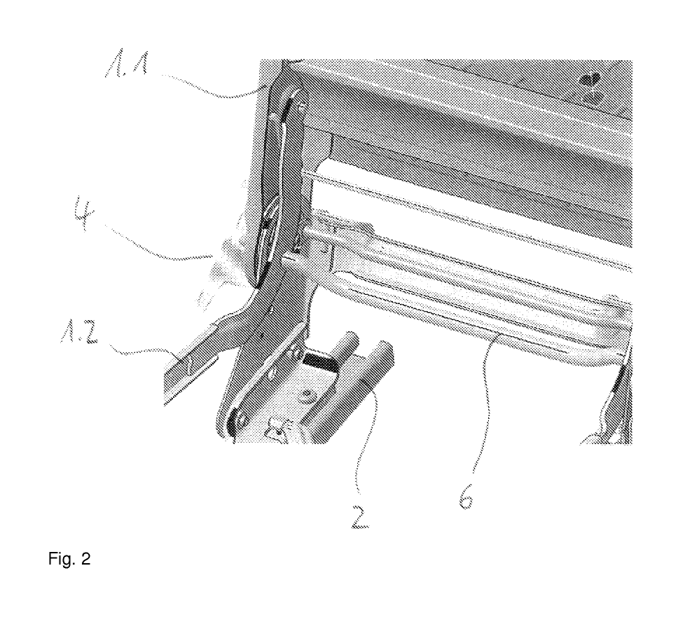

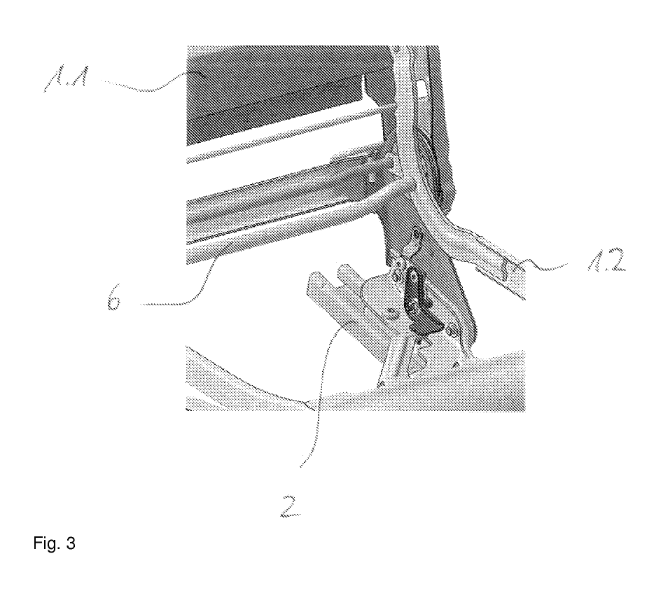

FIGS. 2 and 3 both show an enlarged detail of the supporting structure 1 of the vehicle seat in a perspective view, wherein a region in which the backrest 1.1 is connected to the seat cushion support 1.2 is illustrated.

FIG. 2 shows the region of the supporting structure 1, in which region the comfort lever 4 is arranged, and FIG. 3 shows the opposite region.

The backrest 1.1 is pivotable, wherein a pivot axis runs in the direction of transverse extent of the vehicle, and the pivoting can be triggered firstly by actuation of the unlocking lever 3 of the easy-entry system and secondly by actuation of the comfort lever 4.

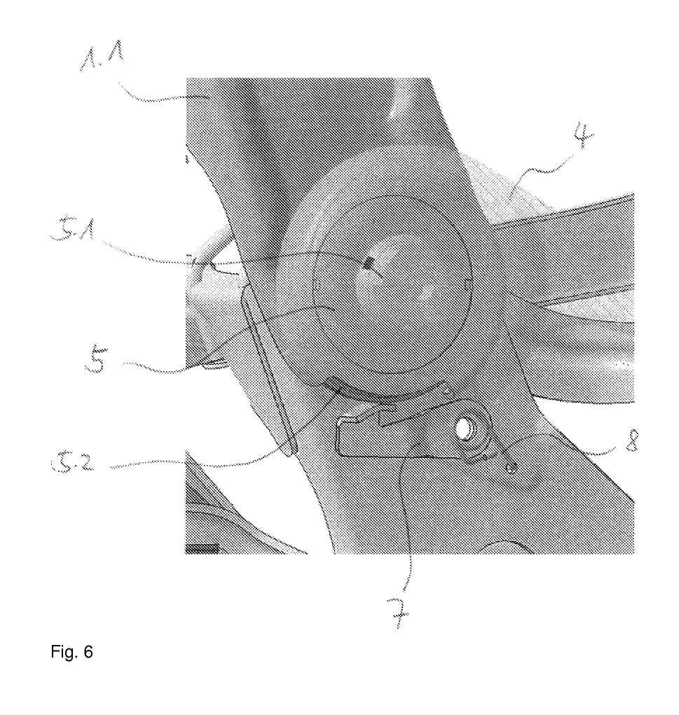

A fitting 5 which is formed from a fitting component B, a fitting upper part B1 and a fitting lower part B2 is arranged on each side of the backrest 1.1. The fitting upper part B1 is arranged in this case mounted on the backrest and the fitting lower part B2 is arranged mounted on the substructure. The fitting upper part B1 on which the comfort lever 4 is arranged is illustrated in more detail at least in FIG. 6. The fitting component B is of disk-shaped design and permits a rotational movement relatively between the fitting upper part B1 and the fitting lower part B2.

The fitting components B arranged on each side of the backrest 1.1 are coupled to each other via a transmission element 6 in the form of a cranked transmission rod or of a tube, and therefore a locking of the backrest 1.1 on both sides can be cancelled in order to be able to pivot the backrest. In particular, in each case one fitting component B is fastened in an interlocking manner to one end of the transmission element 6.

The unlocking lever 3 as part of the easy-entry system for triggering the easy-entry function is directly coupled to the transmission element 6 via a Bowden cable (not illustrated specifically) and/or another suitable element. That is to say, one end of the Bowden cable and/or of the other element is connected to the unlocking lever 3 and an opposite end of the Bowden cable and/or of the other element is connected to the transmission element 6.

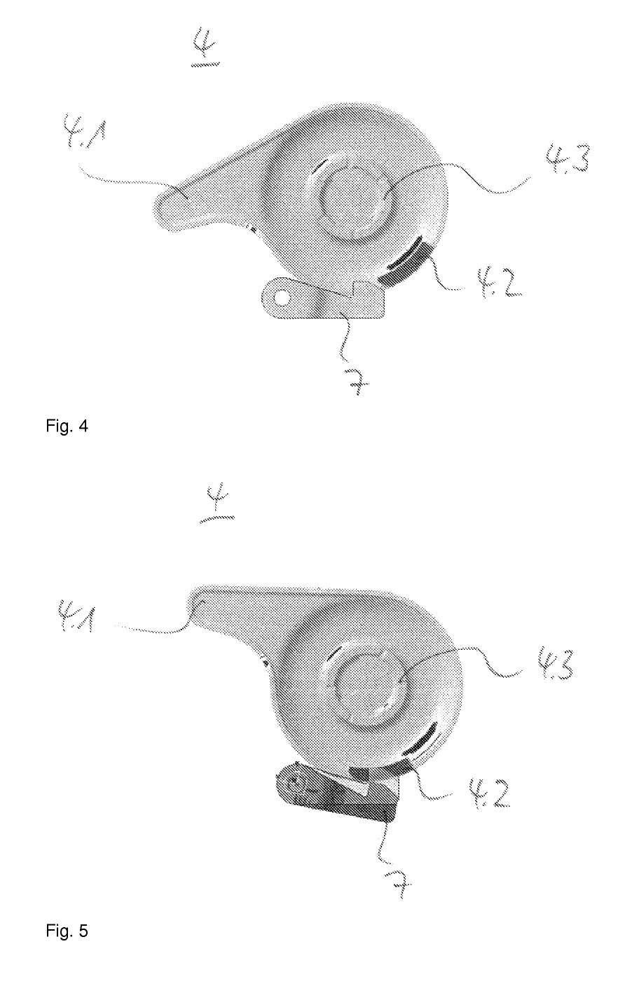

FIGS. 4 and 5 both show the comfort lever 4 with a spring-loaded pawl 7 in operative connection therewith. The comfort lever 4 and the pawl 7 are illustrated in a first position in FIG. 4 and in a second position in FIG. 5.

The comfort lever 4 is of substantially circular design and has a protruding lever 4.1 which is provided for actuation by a vehicle occupant.

In the region of circular design, the comfort lever 4 has a formation 4.2 which protrudes perpendicularly to the longitudinal extent of the comfort lever 4 and extends by a predetermined portion at the edge of the circular region.

A profile 4.3 corresponding to a carry-along profile 5.1, which is shown in FIG. 6, is formed in the center of the circular region of the comfort lever 4.

The pawl 7 is arranged on the fitting lower part B2 and is in engagement with a recess 5.2 of the fitting upper part B1, wherein a spring element 8, which is shown in FIG. 6, is virtually released in this position of the pawl 7, i.e. has a residual tension. The spring element 8 is substantially designed as a leg spring.

The engagement between the fitting upper part B1 and the pawl 7 can be canceled by actuation of the comfort lever 4, as is shown in the second position in FIG. 5. The comfort lever 4 is rotated by the actuation, wherein the pawl 7 and the formation 4.2 are shaped in such a manner that the pawl 7 is brought out of engagement by means of the formation 4.2. The pawl 7 is positioned in this case counter to a spring force acting by means of the spring element 8.

By means of the pawl 7 which is in engagement with the fitting upper part B1, in particular the recess 5.2 thereof, a pivoting range of the backrest 1.1 when the easy-entry function is triggered is limited.

If the operative connection between the pawl 7 and the fitting upper part B1 is cancelled by actuation of the comfort lever 4, the pivoting range of the backrest 1.1 is no longer limited, and therefore the backrest 1.1 is positionable in a desired position or can be pivoted into the position of the loading floor function.

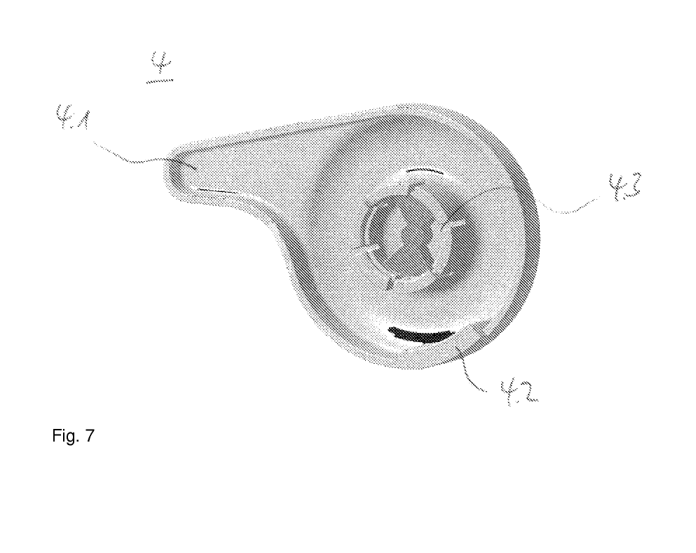

FIG. 7 illustrates the rear side of the comfort lever 4 in a perspective view, wherein the protruding formation 4.2 and the profile 4.3 which corresponds to the carry-along profile 5.1 of the fitting component B of the fitting 5 are shown in the detail. The carry-along profile 5.1 and the corresponding profile 4.3 are formed in such a manner that a freewheel of greater than 30° is provided. Such a freewheel is required to the effect that, in the event of unlocking by actuation of the unlocking lever 3, the comfort lever 4 remains in the position thereof and therefore the pawl 7 limits an easy-entry travel, i.e. the pivoting movement of the backrest 1.1. The freewheel therefore serves for decoupling the unlocking lever 3 from the comfort lever 4.

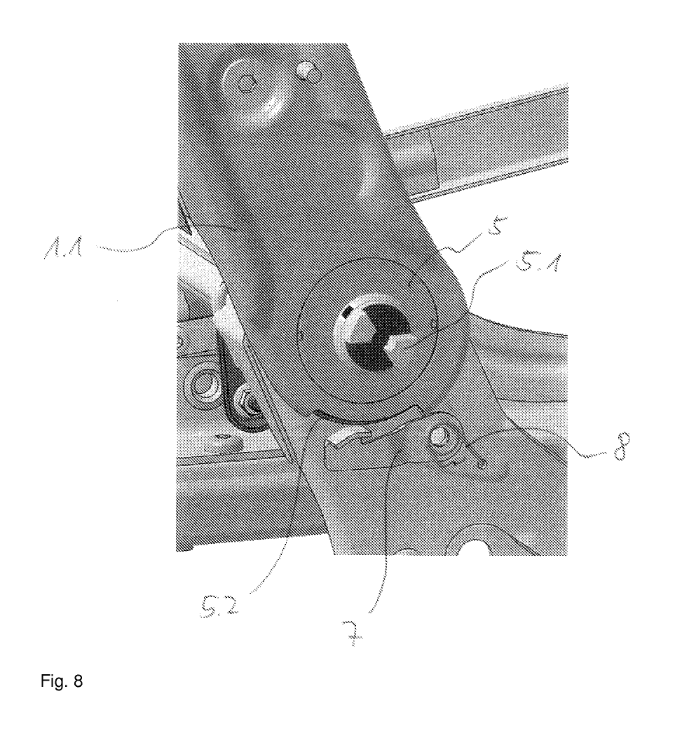

FIG. 8 shows an enlarged detail of the supporting structure 1, in which the fitting 5 with the carry-along profile 5.1 and the pawl 7 are arranged. The fitting component B with the carry-along profile 5.1 has a disk shape and is fixedly connected in particular in an interlocking manner to the transmission element 6. The transmission element 6 unlocks the fitting 5 via an eccentric (not illustrated specifically).

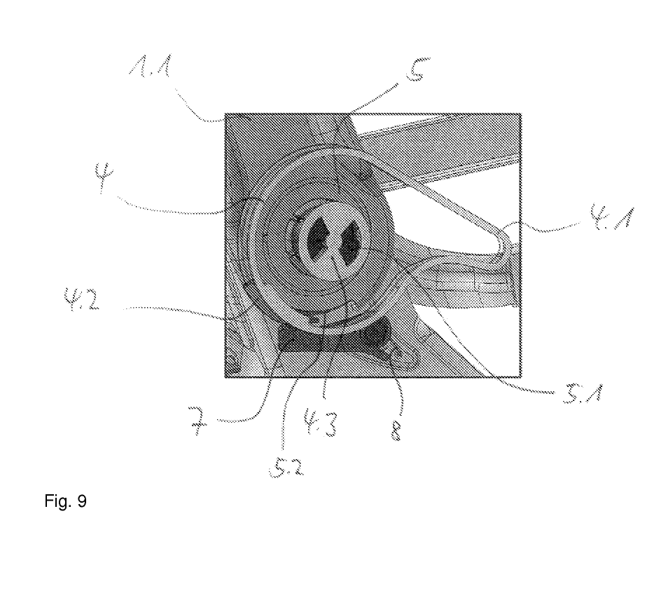

FIGS. 9 to 11 illustrate a contour of the comfort lever 4 arranged on the backrest 1.1, in particular on the fitting component B.

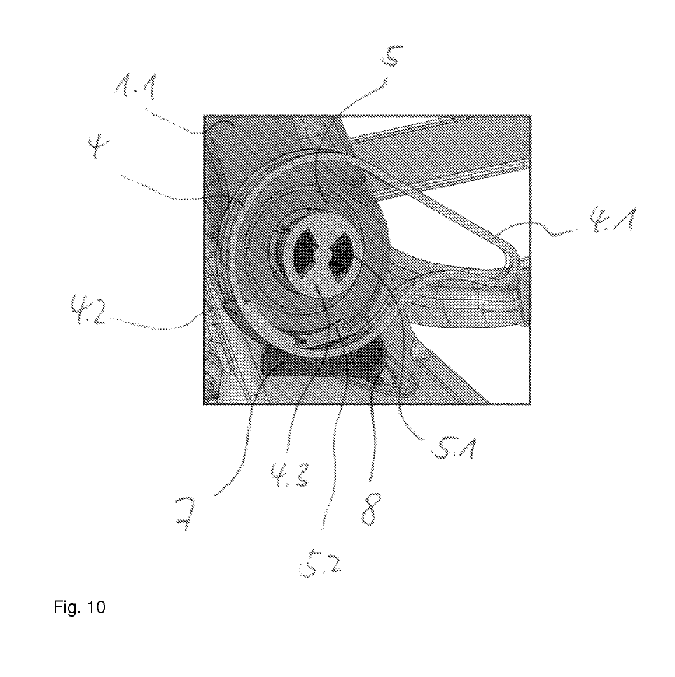

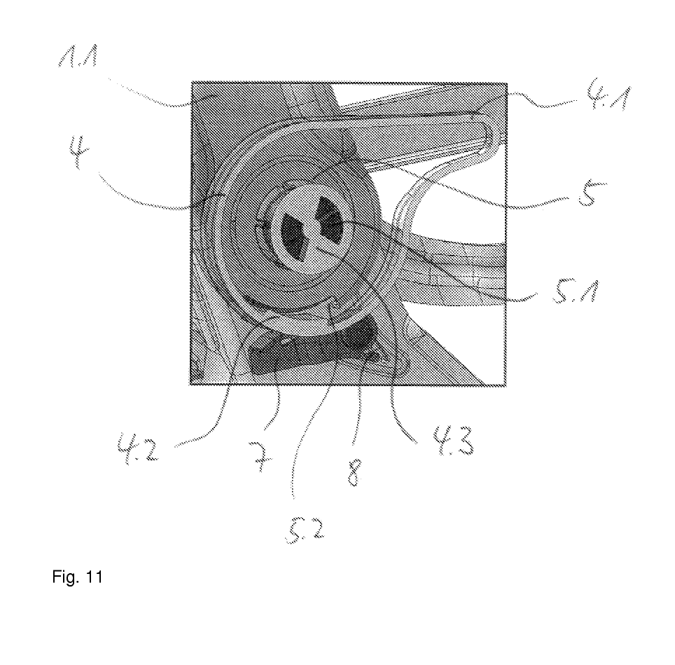

FIG. 9 shows the comfort lever 4 in a position in which none of the possible functions with regard to the pivoting of the backrest 1.1 is triggered. In FIG. 10, the easy-entry function is triggered, and in FIG. 11, the comfort lever 4 for adjusting a position of the backrest 1.1 or for positioning the backrest 1.1 into the loading floor position is actuated.

In FIG. 9, the comfort lever 4 is shown in a starting position, i.e. when not actuated.

Formations of the fitting component B, the formations forming the carry-along profile 5.1, bear in this case against edge regions of the profile 4.3 of the comfort lever 4, the profile corresponding to the carry-along profile 5.1. The pawl 7 is in engagement with the fitting upper part B1 and is therefore arranged in the recess 5.2 thereof.

In FIG. 10, the unlocking lever 3 of the easy-entry system is actuated, wherein the actuation is transmitted via the Bowden cable and/or the other element to the transmission element 6, which is connected fixedly to the fitting component B. By means of the actuation, the fitting component B with the carry-along profile 5.1 rotates relative to the comfort lever 4, wherein the formations forming the carry-along profile 5.1 move within the corresponding profile 4.3 without there being an operative connection. In other words, the unlocking lever 3 is decoupled from the comfort lever 4.

In FIG. 11, the comfort lever 4 is actuated, as a result of which the pawl 7 is no longer in engagement with the fitting upper part B1, and therefore the backrest 1.1 is positionable in a desired position and/or in the loading floor position.

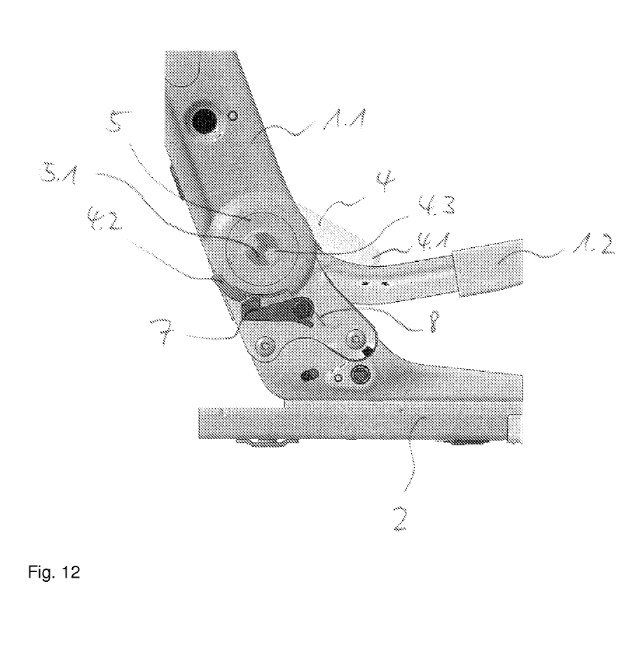

FIG. 12 shows an enlarged detail of the region of the supporting structure, in which region the comfort lever 4 is arranged. The comfort lever 4 is not actuated and the pawl 7 is in engagement with the fitting upper part B1.

FIG. 13 illustrates a side view of the supporting structure 1, wherein the unlocking lever 3 is actuated in order to trigger the easy-entry function. This actuation can be transmitted via the Bowden cable and/or the further element and via the transmission element 6 in the form of the cranked transmission rod to the fitting component B and therefore to the carry-along profile 5.1. The pawl 7 is in engagement in this case with the fitting upper part B1.

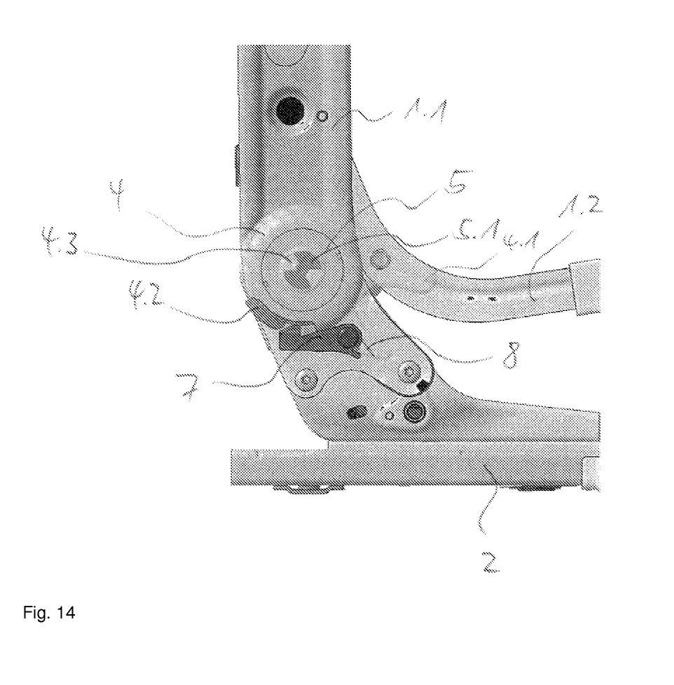

FIG. 14 shows the enlarged detail according to FIG. 12, wherein the backrest 1.1 is located in an upright position because of the triggered easy-entry function and the pawl 7 is in engagement with the fitting upper part B1.

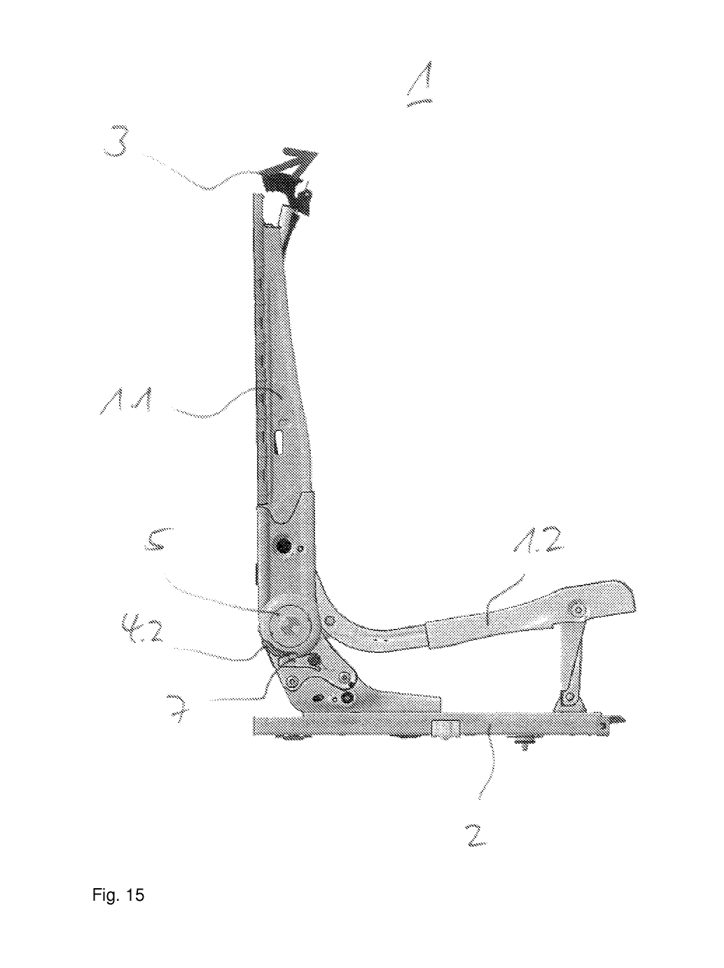

FIG. 15 shows the supporting structure 1 of the vehicle seat in a side view corresponding to the enlarged detail according to FIG. 14.

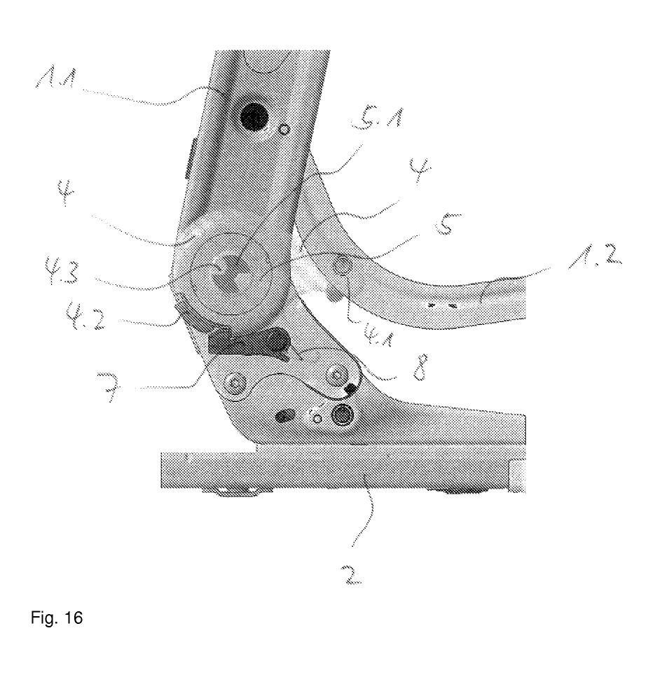

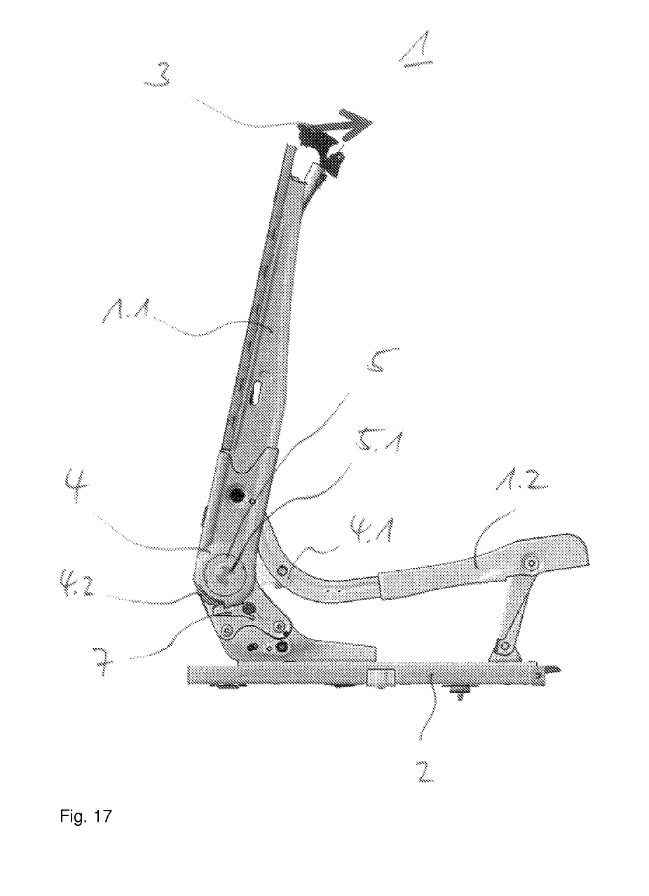

In FIGS. 16 and 17, the backrest 1.1 is in the end position thereof in accordance with the easy-entry function, since the pivoting range, as described above, is limited.

The pawl 7 which is provided for limiting the pivoting range bears against an edge region of the recess 5.2 of the fitting upper part B1, and therefore the backrest 1.1 cannot be pivoted further in the direction of travel.

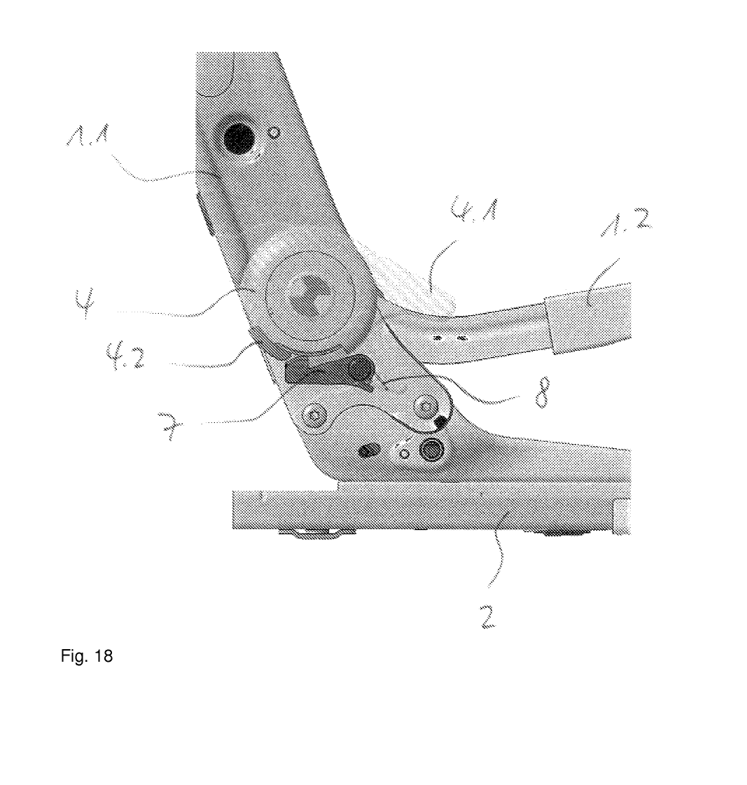

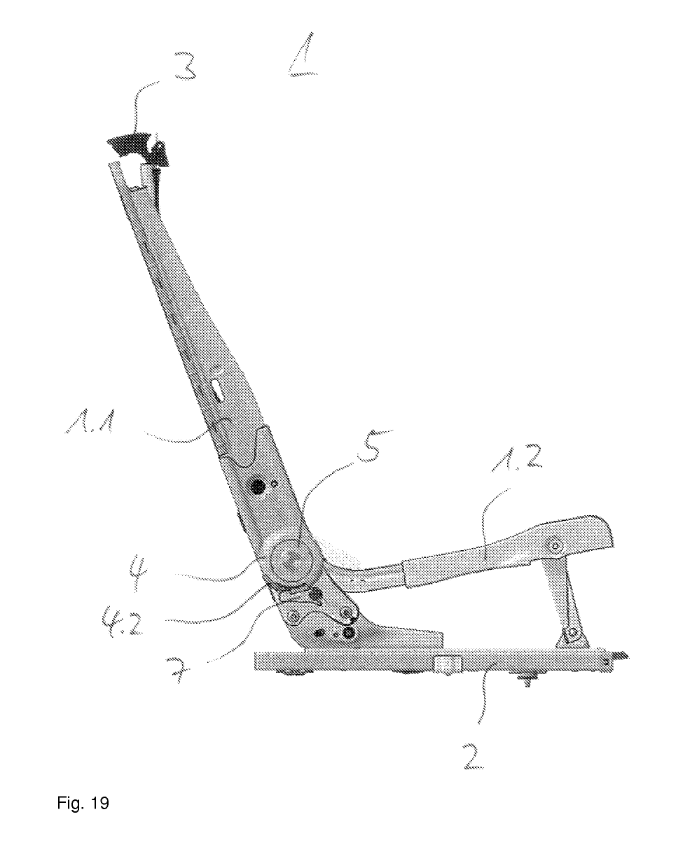

FIGS. 18 and 19 show the supporting structure 1 of the vehicle seat in a starting position, in which the backrest 1.1 is arranged at an angle, which is predetermined by a vehicle occupant, with respect to the seat cushion support 1.2.

From the position illustrated in FIGS. 18 and 19, the backrest 1.1 is intended to be pivoted into a position of the loading floor function.

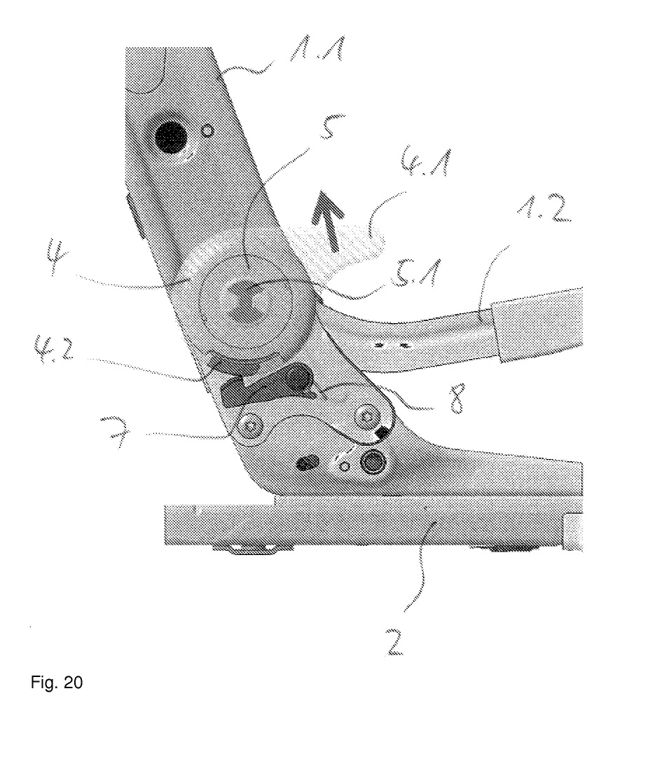

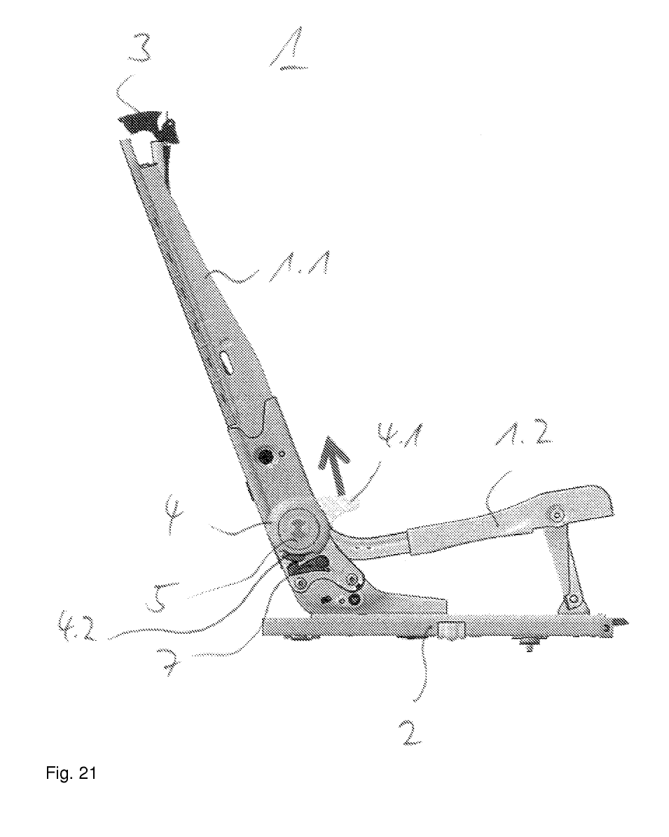

For this purpose, the comfort lever 4 is actuated, wherein the lever 4.1 is pulled upward, as a result of which the comfort lever 4 is rotated. The formation 4.2 of the comfort lever 4 is thereby positioned in the direction of the pawl 7 in such a manner that the latter is moveable away from the comfort lever 4 counter to the spring force of the spring element 8. By means of the moving away or else pivoting away of the pawl 7 by means of the formation 4.2 of the comfort lever 4, the pawl 7 is no longer in engagement with the fitting upper part B1, as is shown in FIGS. 20 and 21.

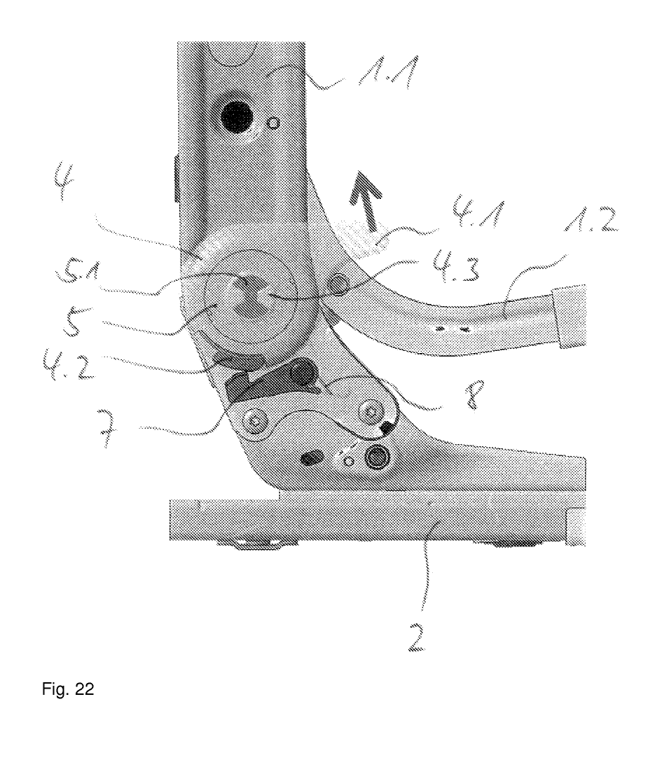

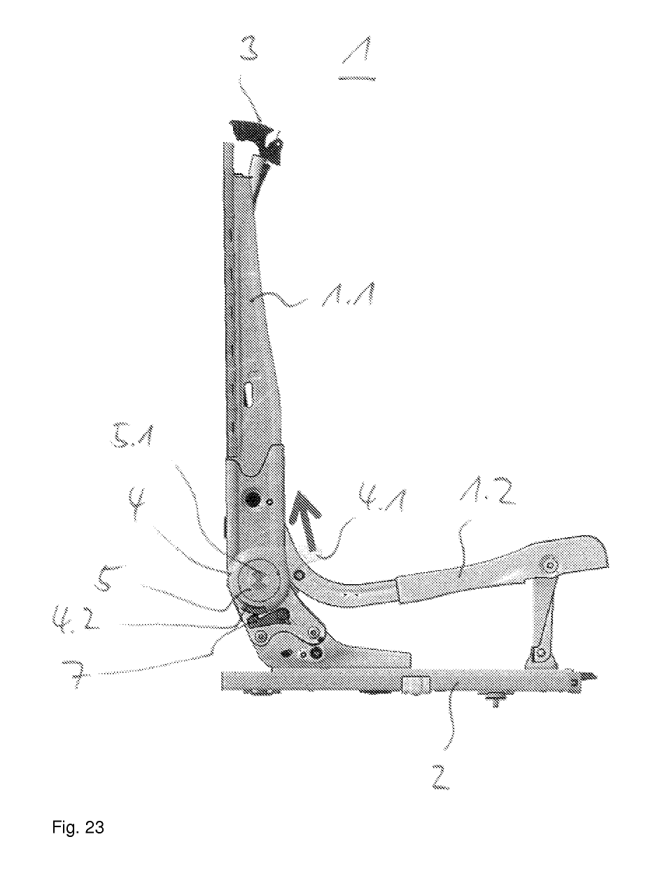

FIGS. 22 and 23 show the backrest 1.1 during the pivoting into the position of the loading floor function, wherein the backrest 1.1 has an upright position.

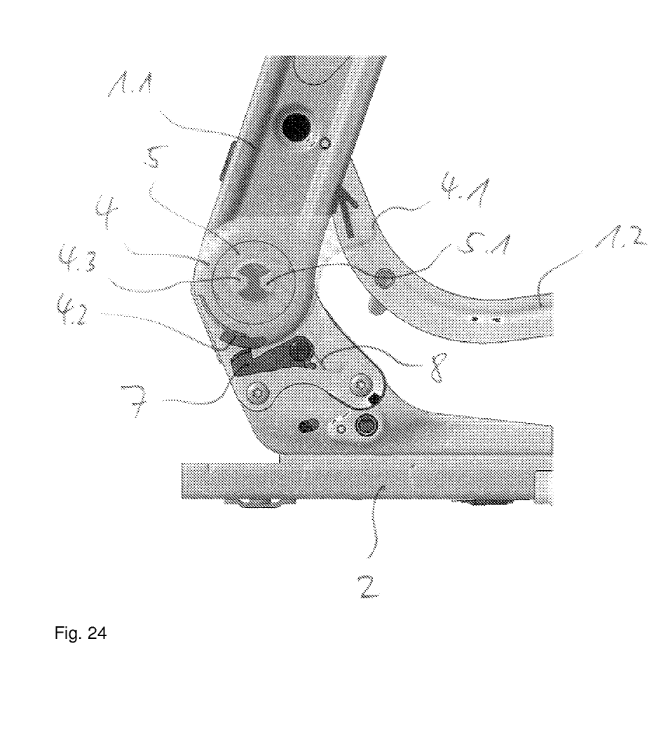

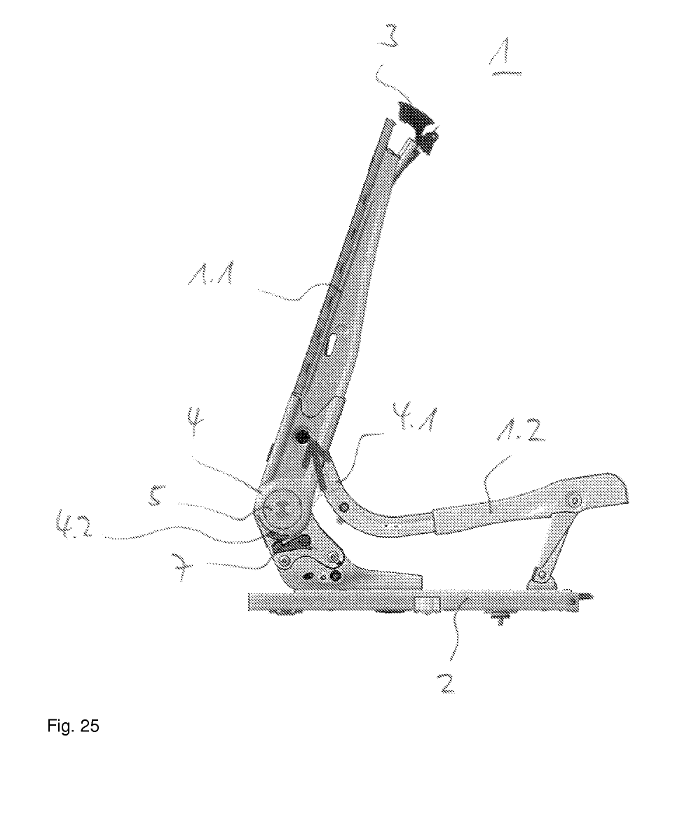

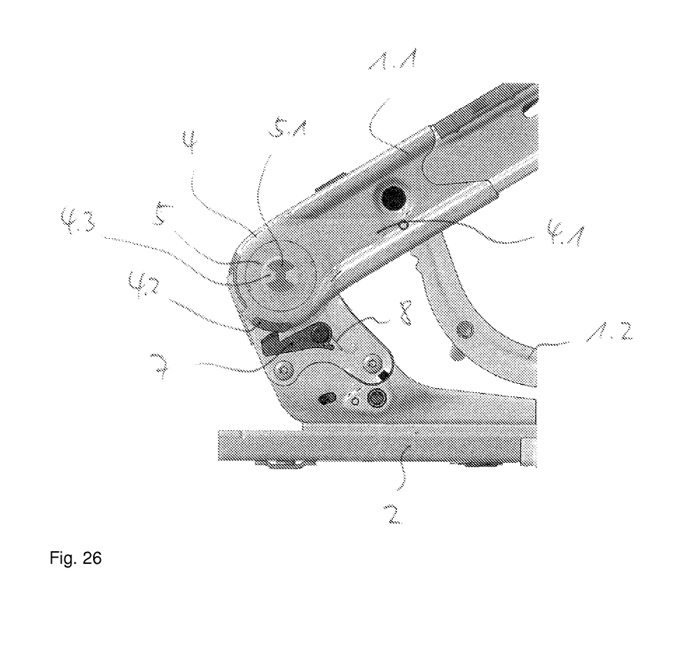

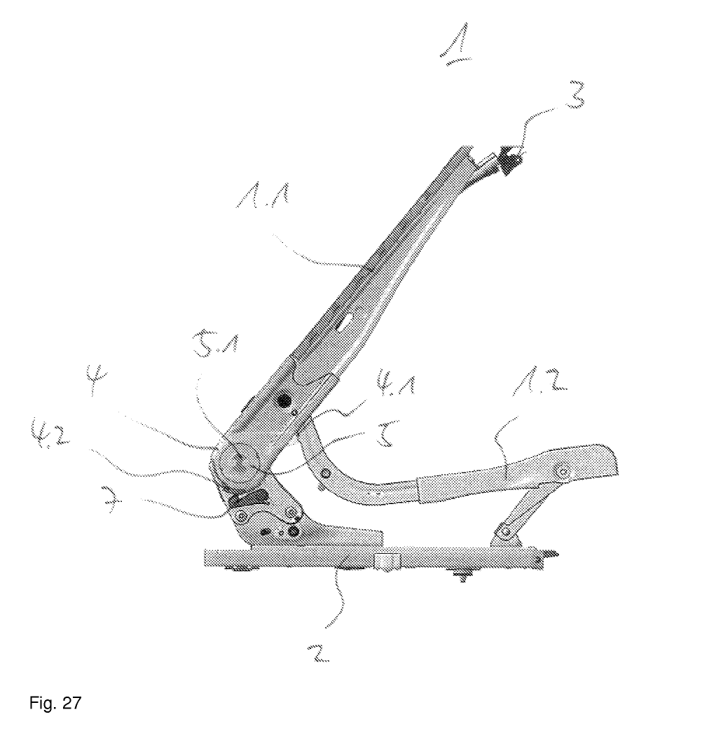

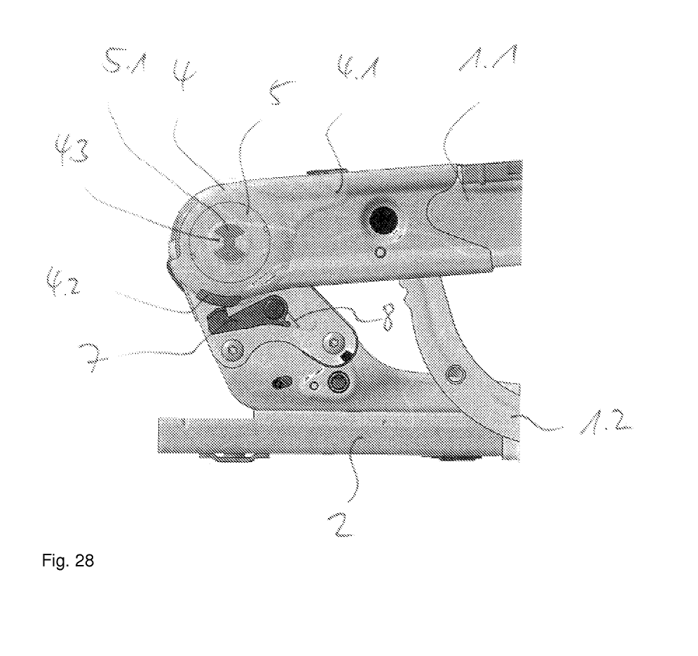

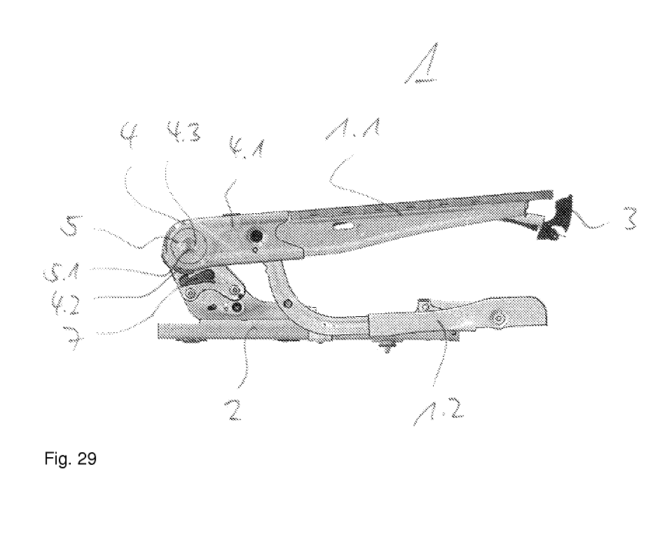

FIGS. 24 to 27 show various pivoting positions of the backrest 1.1, wherein the pawl 7 is not in engagement with the fitting upper part B1 over the entire pivoting movement of the backrest 1.1 until the position of the loading floor function that is illustrated in FIGS. 28 and 29 is reached.

As an alternative to the pawl 7 being arranged on the fitting lower part B2, the pawl can also be arranged on the fitting upper part B1 and engages in the fitting lower part B2.

In one possible embodiment, the pawl 7 is arranged on a part, which is mounted on the substructure, of the supporting structure 1 and engages, for example, in a recess which is formed on a backrest strut of a frame forming the backrest 1.1. The reverse arrangement is also conceivable.

If a comfort setting is not provided on the vehicle seat, the comfort lever 4 serves exclusively for the setting of the loading floor position of the vehicle seat.

While specific embodiments of the invention have been shown and described in detail to illustrate the application of the principles of the invention, it will be understood that the invention may be embodied otherwise without departing from such principles.

1. An easy-entry system for a vehicle seat, the easy-entry system comprising:
at least one fitting with at least one fitting component;
a carry-along profile;
a transmission element, wherein the at least one fitting component is coupled to the transmission element;
an unlocking lever of the easy-entry system connected at least indirectly to the transmission element, the unlocking lever triggering an easy-entry function
a pawl; and
a backrest comfort lever in engagement with the carry-along profile, wherein a pivoting range of the backrest, when the easy-entry function is triggered, is limited by the pawl engaging in the at least one fitting, wherein engagement of the pawl in the at least one fitting is cancelled by actuating the backrest comfort lever in order to adjust a position of the backrest.

2. The easy-entry system as claimed in claim 1, wherein the pivoting range of the backrest is limited by the pawl engaging in a recess of the at least one fitting.

3. The easy-entry system as claimed in claim 1, wherein the comfort lever has a profile corresponding to the carry-along profile.

4. The easy-entry system as claimed in claim 1, wherein the transmission element is connected to the fitting component in at least one of a frictional, an interlocking and an integrally bonded manner.

5. The easy-entry system as claimed in claim 3, wherein, when the unlocking lever is actuated, formations forming the carry-along profile move without operative connection within the corresponding profile.

6. The easy-entry system as claimed in claim 1, wherein the unlocking lever is coupled to the transmission element via a tension element comprising a Bowden cable.

7. The easy-entry system as claimed in claim 1, further comprising a spring element, wherein pawl is coupled to the spring element which, on engagement of the pawl in the recess of the at least one fitting, has a residual tension.

8. The easy-entry system as claimed in claim 7, wherein the spring element is a leg spring, wherein one leg is connected to the pawl and a further leg is connected to the backrest of the vehicle seat.

9. A vehicle seat comprising:
a seat member;
a backrest; and
an easy-entry system comprising:
at least one fitting with at least one fitting component;
a carry-along profile;
a transmission element, wherein the at least one fitting component is coupled to the transmission element;
an easy-entry unlocking lever connected at least indirectly to the transmission element, the unlocking lever triggering an easy-entry function;
a pawl; and
a backrest comfort lever in engagement with the carry-along profile, wherein a pivoting range of the backrest, when the easy-entry function is triggered, is limited by the pawl engaging in the at least one fitting, wherein engagement of the pawl in the at least one fitting is cancelled by actuating the backrest comfort lever in order to adjust a position of the backrest.

10. The vehicle seat as claimed in claim 9, wherein the pivoting range of the backrest is limited by the pawl engaging in a recess of the at least one fitting.

11. The vehicle seat as claimed in claim 9, wherein the comfort lever has a profile corresponding to the carry-along profile.

12. The vehicle seat as claimed in claim 9, wherein the transmission element is connected to the fitting component in at least one of a frictional, an interlocking and an integrally bonded manner.

13. The vehicle seat as claimed in claim 12, wherein, when the unlocking lever is actuated, formations forming the carry-along profile move without operative connection within the corresponding profile.

14. The vehicle seat as claimed in claim 9, wherein the unlocking lever is coupled to the transmission element via a tension element comprising a Bowden cable.

15. The vehicle seat as claimed in claim 9, further comprising a spring element, wherein the pawl is coupled to the spring element which, on engagement of the pawl in the recess of the at least one fitting, has a residual tension.

16. The vehicle seat as claimed in claim 15, wherein the spring element is a leg spring, wherein one leg is connected to the pawl and a further leg is connected to the backrest of the vehicle seat.
